(19) United States
(12) Patent Application Publication
(10) Pub. No.: US 2014/0175752 A1
(43) Pub. Date: Jun. 26, 2014

(54) Dual Shaft Arrangement with Adjustable Axial Spacing and Improved Sealing Unit

(71) Applicants: Leonhard Heinrichsmeier, Talheim (DE); Claus Eberhardt, Schwaigern (DE); Claus Ulrich, Obersulm-Suelzbach (DE)

(72) Inventors: Leonhard Heinrichsmeier, Talheim (DE); Claus Eberhardt, Schwaigern (DE); Claus Ulrich, Obersulm-Suelzbach (DE)

(73) Assignee: HOSOKAWA BEPEX GMBH, Leingarten (DE)

(21) Appl. No.: 13/643,713

(22) PCT Filed: Apr. 14, 2011
(86) PCT No.: PCT/EP11/01903

§ 371 Date: May 31, 2013

(30) Foreign Application Priority Data
Apr. 27, 2010 (DE) 10 2010 018 421.7

(51) Int. Cl. F16J 15/32

(52) U.S. Cl. CPC F16J 15/3204
USPC 277/353

(57) ABSTRACT

The invention relates to a device having two rotational shafts which are arranged at least essentially parallel to each other and associated with rotational axes (13a, 15a) separated by means of an adjustable distance. The shafts extend respectively through a wall (28) which separates a drive side from the product side, and are sealed with respect to the wall (28). In order to improve sealing between the product side and the drive side, the sealing of said type of arrangement is maintained between each shaft (13) comprising an adjustable rotational axis and the wall (28) by means of a sealing unit (32) which surrounds the associated shaft (13) in the region of the wall (28); when the rotational axis is adjusted, said sealing unit remains in its position with respect to said rotational axis; said sealing unit (32) comprises, radially inwards, a dynamic seal for sealing between the rotational shaft (13) and the sealing unit (32), and radially outwards, a static sleeve seal (52) which is fixed in a sealing manner, radially inwards on the sealing unit (32) and radially outwards, on the wall (28) and comprises an elastic sealing collar (58).

### TECHNICAL FIELD

The present invention relates to a device, for example a roller press, having two rotatable shafts which are arranged at least substantially parallel to one another and have associated rotational axes whereof the mutual spacing is adjustable, wherein the shafts each extend through a wall which separates a drive side from a product side and are sealed with respect to the wall.

### BACKGROUND OF RELATED ART

Devices having two shafts arranged parallel to one another are frequently used in the production and processing industry. It is often important here to separate a drive side of a dual shaft arrangement of this type from a product side of the same arrangement so that dirt from the drive side cannot reach the product side and product is unable to leak towards the drive side. If the spacing between the rotational axes is adjustable, the sealing between the drive side and the product side has to ensure effective sealing even when the spacing between the rotational axes is adjusted. In such cases, radially elastic dynamic seals are conventionally used, i.e. when the shafts are rotating, there is a constant relative movement between the surface to be sealed and the seal at at least one sealing surface. This results in a relatively high degree of wear on the seal and moreover increases the likelihood of undesired wear debris making its way into the product to be processed.

A typical dual shaft arrangement is for example a roller press having two rotatable rollers which are arranged parallel to one another and form a roller gap between them through which material to be processed is guided during operation. Such roller presses can be used for example for granulating fine powder in order to simplify subsequent processing of the powder. Roller presses of this type are also known as Kompaktor®.

### SUMMARY

The object of the invention is to improve the sealing between the drive side and the product side in devices of the type mentioned so that, despite an adjustable spacing between the rotational axes, it is possible to maintain excellent sealing over a very long operating period and, as far as possible, at the same time prevent the product from being contaminated by foreign matter.

Starting with a device mentioned at the outset, this object is achieved according to the invention in that the sealing between each shaft with an adjustable rotational axis and the wall is effected by means of a sealing unit which surrounds the associated shaft in the region of the wall and maintains its relative position to the rotational axis when this rotational axis is adjusted, wherein the sealing unit comprises, radially inwards, a dynamic seal for sealing between the rotatable shaft and the sealing unit and, radially outwards, a static collar seal which is fixed in sealing manner radially inwards on the sealing unit and radially outwards on the wall and comprises an elastic sealing collar.

Therefore, according to the invention, the sealing action is assumed by a sealing unit which has a rigid base body which surrounds the shaft to be sealed concentrically and does not move relative to the central axis of the shaft, i.e. it follows the adjusting movement when the rotational axis of this shaft is adjusted. Secured radially inwards on this rigid base body is a dynamic seal whereof the operating conditions do not alter when the rotational axis is adjusted since the dynamic seal is unaffected by an adjustment of the rotational axis. This dynamic seal can be optimised accordingly to the actual shaft seal and does not need to compensate any axial offset, radial offset and/or misalignment between the rotational axes which can be reinforced particularly when the rotational axes are adjusted. This compensation is instead assumed by the static collar seal which is mounted radially outwards on the rigid base body and is not subject to any wear as a result of a rotating relative movement and therefore has an extremely long service life. The type of elastic sealing collar is selected so that it can tolerate the desired adjustment range without being subject to excessive stress. With relatively small adjustment spacings, the elastic sealing collar can be constructed for example in the manner of a flat membrane, whereas a bellows-shaped design of the elastic sealing collar lends itself to relatively large adjustment spacings.

In preferred embodiments of the device according to the invention, the dynamic seal has two sealing elements which are arranged axially following one another and are preferably radial lip seals. Two sealing elements arranged axially following one another improve the efficiency of the sealing on the one hand and prevent wear on the seal on the other, since it is possible to select a lower pressure force for each individual sealing element. A further advantage of such an arrangement is that the front seal, which is exposed to the material to be processed, can be replaced without the risk of the material reaching the drive side.

If the sealing elements of the dynamic seal are constructed as radial lip seals, then an axially inner radial lip seal of the two radial lip seals is preferably assembled by means of a clamping ring which rests in an outer circumferential groove of the radial lip seal. The clamping ring preferably has a circular cross-section and ensures that the axially inner radial lip seal is unable to move, particularly unable to rotate, in the bore in which it is received. The clamping ring is made of a suitable elastomer material.

An axially outer radial lip seal of the two radial lip seals of the dynamic seal is preferably assembled axially on a holding ring which is arranged in the bore receiving the axially outer radial lip seal and spreads the radial lip seal somewhat radially outwards. The radial lip seal is thus reliably fixed in the bore and the radial lip seal is prevented from rotating during operation. The holding ring preferably has a T-shaped cross-section and is positioned with its base in the radial lip seal. The two transverse limbs of the T-shaped cross-section can then serve to axially support the axially outer radial lip seal on the axially inner radial lip seal.

All in all, the two radial lip seals assembled as described above realise a fixing thereof in the associated bore without screws or similar elements, which enables simple assembly of the radial lip seals by simple insertion into the bore on the one hand and dispenses with potential contamination-sensitive securing points on the other.

In a preferred embodiment of the device according to the invention, the static collar seal has an approximately M-shaped cross-section with two outer, thicker limbs which serve to fix the collar seal on the sealing unit as well as on the wall, wherein the elastic sealing collar, which is preferably connected in one piece to the two outer limbs, extends between the outer, thicker limbs. A first pressure ring serves to fix the static collar seal in place, which pressure ring is secured to a base body of the sealing unit and receives a radially inner limb of the two limbs of the collar seal therein so that an end face of the radially inner limb is pressed against the base body of the sealing unit by means of the first pressure ring. Analogously, a second pressure ring is preferably used to fix the radially outer limb of the two limbs of the collar seal in place, which pressure ring is secured to the wall and preferably receives the radially outer limb such that an end face of the radially outer limb is pressed against the wall by means of the second pressure ring. The first and the second pressure ring are preferably arranged on the drive side of the device so that only the elastic sealing collar is exposed to the product on the product side.

### BRIEF DESCRIPTION OF THE DRAWINGS

A currently preferred exemplary embodiment of a device according to the invention in the form of a roller press is explained in more detail below with reference to the accompanying schematic drawings, which show:

FIG. 1 a three-dimensional illustration of a roller press having the sealing between the product area and drive side which is improved according to the invention;

FIG. 2 a front view of the roller press of FIG. 1 from the front;

FIG. 3 the section III-III from FIG. 2; and

FIG. 4 an enlarged illustration of part of FIG. 3, which shows a sealing unit in detail.

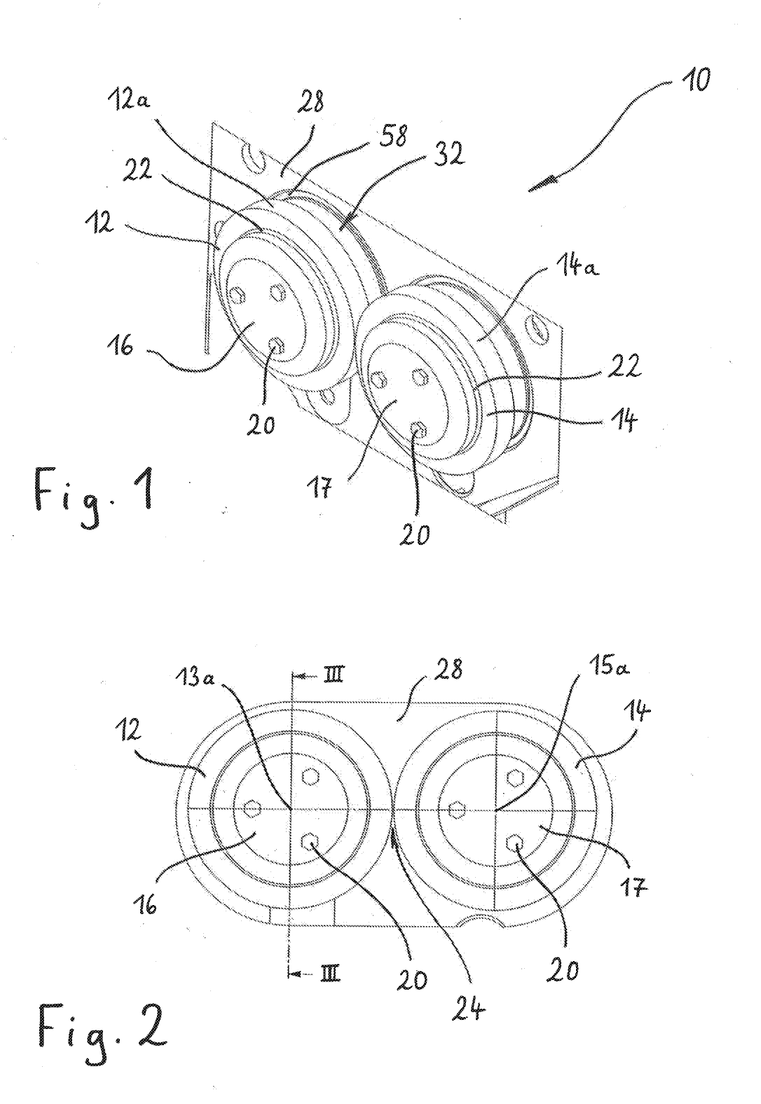

### DETAILED DESCRIPTION

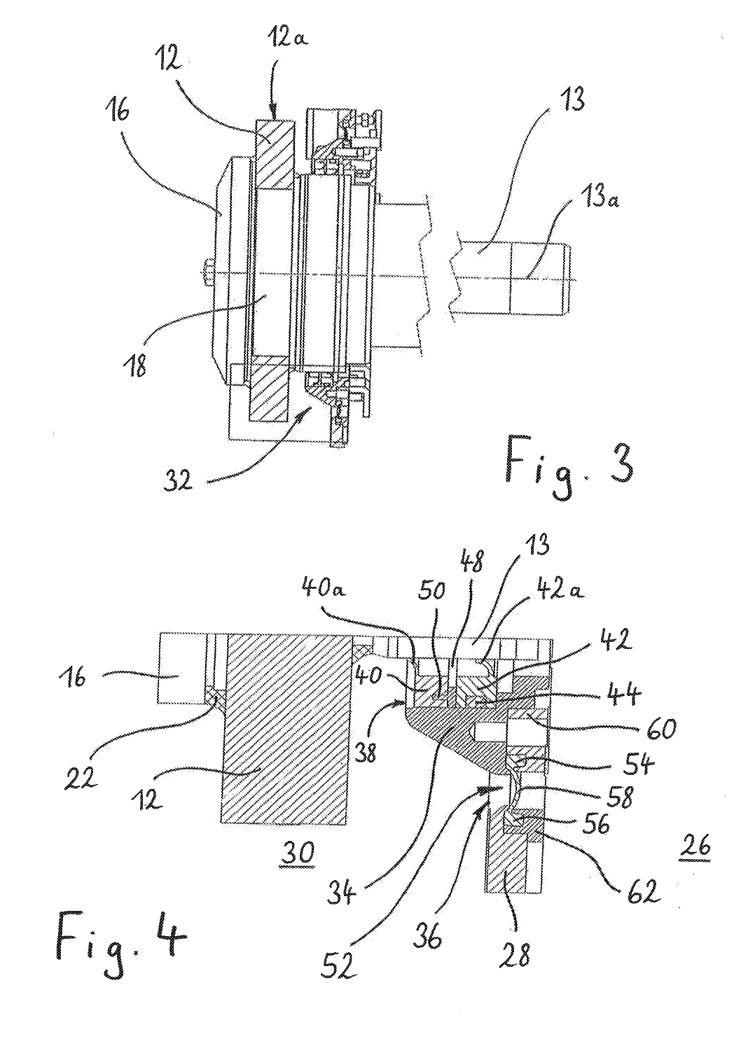

The Figures show a roller press for use as a Kompaktor®, for example in the pharmaceutical industry, which is denoted in general by 10. The roller press 10 has a first roller 12 and a second roller 14, which each have a cylindrical operating surface 12a and 14a and are secured on an associated shaft serving to drive them rotationally, of which a shaft 13 is shown in FIG. 3. The two drive shafts specify mutually parallel rotational axes 13a, 15a (see FIG. 2) about which the rollers 12, 14 rotate in opposite directions during operation.

Each roller 12, 14 is secured by means of an associated pressure cap 16, 17 on a drive journal 18 (see FIG. 3) of the associated shaft. In the exemplary embodiment shown, each pressure cap 16, 17 is fixedly screwed on the associated drive journal 18 by means of three screws 20 and clamps the associated roller 12 and 14 axially on the corresponding shaft. For sealing between the pressure cap 16 and 17 and the respectively facing end face of each roller 12 and 14, the outer edge of that side of the pressure cap 16 and 17 which faces the roller is formed by a static lip seal 22. This lip seal 22 enables a sealing between the pressure cap 16 and 17 and the end face of the associated roller 12 and 14 which has no gaps and therefore no clearance volume and which prevents product deposits in this region and is easy to clean.

Between them, the two rollers 12, 14 form a roller gap 24 (see FIG. 2) in the region of the operating surfaces 12a, 14a to which the powder material can be supplied in order for it to be granulated by the pressing action occurring as it passes through the roller gap 24. So that the extent of the pressing action in the roller gap 24 can be adapted to the powder to be processed and/or the product requirements, the mutual spacing of the two rotational axes 13a, 15a can be adjusted during operation. In the exemplary embodiment shown, both rotational axes 13a, 15a are designed to be adjustable by means of devices which are not shown.

Each shaft associated with the two rotational axes 13a, 15a (only the shaft 13 is shown) extends from a drive side 26 (see FIG. 4) through a wall 28 to a product side or into a product area 30 in which the two rollers 12, 14 are located. Located on the drive side 26 here are devices (not illustrated in more detail) for driving the two shafts supporting the rollers 12, 14 in rotational manner.

To ensure perfect sealing between the drive side 26 and the product side 30 and, as far as possible, to prevent foreign matter from entering the product area 30, the shaft 13 is surrounded concentrically by a sealing unit 32 in the region of the wall 28, which sealing unit has a rigid base body 34 which acts as a supporting element and whereof the external diameter is clearly smaller than the diameter of a through opening 36 in the wall 28 through which the shaft 13 extends. As a result of this difference in diameter, it is possible to shift the rotational axis 13a of the shaft 13 radially within the clearance produced by the difference in diameter and therefore alter the spacing between the two rotational axes 13a and 15a. The rigid base body 34 of the sealing unit 32 is fixed relative to the shaft 13, i.e. it does not alter its relative position to the rotational axis 13a when the rotational axis 13a is adjusted. The rigid base body 34 is designed to taper conically towards the product side 30 in order to make it difficult for product to deposit on its outer side.

The rigid base body 34 has a bore 38 which is open towards the product side 30, is concentric with the rotational axis 13a and in which two radial lip seals 40 and 42 are assembled such that they follow one another in the axial direction, which radial lip seals function as dynamic shaft seals and, to this end, are provided on their radially inner side with a respective circumferential sealing lip 40a, 42a which contact the outer side of the shaft 13. The sealing lips 40a, 42a are curved as seen in cross-section in such a way that product which arrives at the radial lip seals 40, 42 does not reach the surface of the shaft 13.

The axially inner radial lip seal 42 is assembled in the bore 38 by means of a clamping ring 44 which is received in an outer circumferential groove 46 of the radial lip seal 42. The clamping ring 46 holds the radial lip seal 42 such that it is fixed in place in the bore 38 and prevents the radial lip seal 42 from likewise rotating when the shaft 13 rotates. As shown, the radial lip seal 42 abuts with its virtually square cross-section against the base of the bore 38.

The axially outer radial lip seal 40 with its likewise virtually square cross-section is supported on the axially inner radial lip seal 42 by way of a holding ring 48 which is received in the bore 38 and has a T-shaped cross-section. A base 50 of the T-shaped cross-section of the holding ring 48 is received completely in the inner end face (as seen in relation to the bore 38) of the radial lip seal 40, wherein the base 50 is wider than the corresponding receiving slot provided in the radial lip seal 40 so that, when the radial lip seal 40 is assembled on the holding ring 48, the overdimension of the base 50 results in a spreading effect which spreads the cross-sectionally virtually square base body of the radial lip seal 40 radially outwards and thereby clamps it in the bore 38. The radial lip seal 40 is thus prevented from shifting or rotating during operation.

A static collar seal 52, which in the exemplary embodiment shown has a virtually M-shaped cross section formed by two outer relatively thick limbs 54, 56 and a thinner elastic sealing collar 58 extending between these limbs and bridging the clearance between them, serves to seal the annular gap produced as a result of the said difference in diameter between the rigid base body 34 and the through opening 36 in the wall 28. The radially inner limb 54 serves to fix the collar seal 52 on the sealing unit 32 and, to this end, is received virtually completely in a first pressure ring 60 which is secured on the drive-side end face of the rigid base body 34 by means of screws (not illustrated) and presses the free end face of the limb 54 against the base body 34 in sealing manner. Analogously, the limb 56 serves to fix the collar seal 52 on the wall 28 and, to this end, is likewise received virtually completely in a second pressure ring 62 which is secured on the wall 28 and presses the free end face of the limb 56 against the wall 28.

Both the first pressure ring 60 and the second pressure ring 62 are therefore arranged on the drive side 26 which means that a product to be processed can only come into contact with the elastic sealing collar 58. The elastic sealing collar 58 is able to deform according to the adjusting movement of the rotational axis 13a without thereby tearing or being subject to excessive stress or pressure. Both the static collar seal 52 and the radial lip seals 40 and 42 are made of an elastomer material which has excellent resistance to the product to be processed and is sufficiently mechanically stable. Suitable materials are known to the person skilled in the art and are therefore not explained here in more detail.

What is claimed is:

1-8. (canceled)

9. A device, comprising:
two rotatable shafts arranged at least substantially parallel to one another and having associated rotational axes with adjustable mutual spacing, wherein the shafts each extend through a wall separating a drive side from a product side and are sealed with respect to the wall,
wherein the sealing between each shaft having the adjustable rotational axis and the wall is effected by a sealing unit which surrounds the associated shaft in a region of the wall and maintains its relative position to the rotational axis when this rotational axis is adjusted,
wherein the sealing unit comprises, radially inwards, a dynamic seal for sealing between the rotatable shaft and the sealing unit and, radially outwards, a static collar seal fixed in a sealing manner radially inwards on the sealing unit and radially outwards on the wall and comprises an elastic sealing collar,
wherein the static collar seal includes a radially inner limb received in a first pressure ring secured on a base body of the sealing unit so that an end face of the radially inner limb is pressed against the base body of the sealing unit by the first pressure ring, and a radially outer limb received in a second pressure ring secured on the wall, wherein the first pressure ring and the second pressure ring are arranged on the drive side of the device so that only the elastic sealing collar is exposed to the product on the product side.

10. The device according to claim 9, wherein the dynamic seal includes two sealing elements arranged axially following one another.

11. The device according to claim 10, wherein the sealing elements are two radial lip seals.

12. The device according to claim 11 wherein an axially outer radial lip seal of the two radial lip seals is assembled axially on a holding ring which spreads the radial lip seal radially outwards.

13. The device according to claim 12, wherein the holding ring has a T-shaped cross-section and is positioned with its base in the radial lip seal.

14. The device according to claim 11, wherein an axially inner radial lip seal of the two radial lip seals is assembled by a clamping ring which rests in an outer circumferential groove of the radial lip seal.

15. The device according to claim 14, wherein the clamping ring has a circular cross-section.

16. The device according to claim 1, wherein the static collar seal has an approximately M-shaped cross-section with two outer, thicker limbs which serve to fix the collar seal on the sealing unit and on the wall, between which an elastic sealing collar extends.
